(19) United States
(12) Patent Application Publication
(10) Pub. No.: US 2009/0146541 A1
(43) Pub. Date: Jun. 11, 2009

(54) INFRARED REFLECTOR AND HEATING DEVICE HAVING THE SAME

(75) Inventors: Ken Nakahara, Kyoto (JP); Hiroyuki Yuji, Kyoto (JP); Kentaro Tamura, Kyoto (JP); Shunsuke Akasaka, Kyoto (JP); Masashi Kawasaki, Miyagi (JP); Akira Ohtomo, Miyagi (JP); Atsushi Tsukazaki, Miyagi (JP)

Correspondence Address: RABIN & Berdo, PC, 1101 14TH STREET, NW, SUITE 500, WASHINGTON, DC, 20005, US

(73) Assignee: ROHM CO., LTD., Kyoto-fu (JP)

(21) Appl. No.: 12/044,736

(22) Filed: Mar. 7, 2008

(30) Foreign Application Priority Data
Mar. 9, 2007 (JP) 2007-060583

(51) Int. Cl. H01K 1/26

(52) U.S. Cl. 313/113

(57) ABSTRACT

Provided is an infrared reflector having the configuration in which a dielectric film, an Au (gold) film, and an oxide film are sequentially formed on a substrate. The infrared reflector with this configuration is used so that the oxide film would face a body to be heated. In addition, infrared light emitted from a heat source can be reflected and collected by a reflection metal of the Au film to the body to be heated. Moreover, since the dielectric film is formed on the substrate, it is possible to prevent Au from dispersing under high temperature and thus to prevent deterioration of the infrared reflector.

### CROSS REFERENCE TO RELATED APPLICATIONS AND INCORPORATION BY REFERENCE

This application is based upon and claims the benefit of prior Japanese Patent Application P2007-60583 filed on Mar. 9, 2007; the entire contents of which are incorporated by reference herein.

### BACKGROUND OF THE INVENTION

1. Field of the Invention

The present invention relates to an infrared reflector which is used when heat treatment is carried out in an atmosphere containing oxygen, and a heating device having the infrared reflector.

2. Description of the Related Art

Superconductive oxides such as YBCO, transparent conductive substances such as ITO, giant magnetoresistive materials such as (LaSr)MnO₃ are examples of oxides that have extraordinarily various promising properties, when compared with conventional semiconductors, metals, or organic substances. Thus, the study of oxides has been one of the hottest research fields.

As one of oxides, ZnO has attracted attention because of its multifunctionality and large light-emitting potential. ZnO is formed by molecular beam epitaxy (MBE) that is carried out by using a metal of Zn, and an oxygen radical that is cracked by plasmas and has high reaction activity. During the MBE growth, a growth temperature has to be high in order to obtain a flat surface in a wider region.

A heating device is used to control the growth temperature. In general, a heating device having a lamp heater or a resistance heater includes an infrared reflector for reflecting infrared light emitted from the heater, as disclosed in Japanese Patent Application Publication No. 2002-246325, for example. Such heating device collects heat emitted from the heater with the infrared reflector so as to perform efficient heating. As shown in FIG. 11, for example, the heating device has the configuration in which an infrared reflector 21 is disposed above a resistance heat source 22 so that infrared light emitted from the resistance heat source 22 would be focused on a body to be heated 23.

In addition, along with the advancement of miniaturization of devices in recent years, rapid thermal processing (RTP) has been performed for dispersion annealing after film formation or ion implantation. A lamp annealing device is used as a heating device for RTP. The lamp annealing device has the configuration as shown in FIG. 12, for example. Lamp heat sources 32a are formed of tungsten halogen lamps, and provided for a light emitting unit 32. A furnace body 33 is surrounded by the lamp heat sources 32a. In order to collect infrared light emitted from the lamp heat sources 32a for a body to be heated that is disposed in the furnace body 33, the outer circumference of the light emitting unit 32 is surrounded by an infrared reflector 31a.

The infrared reflectors shown in FIGS. 11 and 12 have to reflect the infrared light in a wide wavelength range. Thus, metals having wavelength dependency of reflectance being relatively small are often used. For example, refractory metals, such as Ta, Wand Au, whose melting point exceeds 1000° C. or inconel, which is an alloy mainly formed of Ni, are often used.

Moreover, oxygen being an element constituting an oxide, such as ZnO, is a chemically active material that can make a compound with any material. Accordingly, when an oxide is grown in an atmosphere containing oxygen or heat treatment is carried out, there is caused a problem that components of the heating device are oxidized and deteriorated by oxygen.

For example, if temperature is high under chemically active oxygen atmosphere, oxygen and the metal constituting the infrared reflector are caused to react with each other. Oxides of Ta and W have strong sublimation. Thus, the infrared reflector becomes thin because the metal constituting the infrared reflector is reduced. On the other hand, such a problem is not caused in the case of using inconel. However, an oxide is formed on the surface thereof, and thereby the surface is blackened. As a result, reflectance is remarkably lowered.

FIG. 13 is a graph showing a state how arrival temperature of the body to be heated is decreased in a case where heat treatment is carried out by using inconel for the infrared reflector inside the heating device. In FIG. 13, numeral X1 shows data obtained when the infrared reflector is used in the heating device for the first time, while reference numeral X2 shows measured data obtained after the infrared reflector was used in the heat treatment in the heating device for 20 times or more. As shown in the graph, the infrared reflector formed of inconel that is used in the heat treatment for many times is less capable of increasing temperature of the body to be heated than the infrared reflector formed of inconel that is not used in the heat treatment at all. This is because the surface of inconel is blackened, so as to decrease reflectance.

Meanwhile, Au and Pt are strong against the above-described oxidation. However, Au and Pt are expensive, and thus cannot be used in the form of a block. For example, they are used by being affixed to some substrate as a foil or a thin film. However, chemical activities of both the foil and thin film are low. Thus, they peel off the substrate very easily. In order to securely join an Au film or Pt film to the substrate, an Ni film or the like is often inserted between the substrate and any one of the Au film and the Pt film. However, with such a configuration, these films are likely to be alloyed. If these films are alloyed, the infrared reflector per se absorbs a large amount of infrared light and temperature of the infrared reflector becomes high. Accordingly, the infrared reflector has to be cooled by water or the like, resulting in making the device larger. As described above, the deterioration of the infrared reflector in the heating device has particularly been a problem in the heat treatment in the atmosphere containing oxygen.

### SUMMARY OF THE INVENTION

The present invention has been made in view of the foregoing problem. Accordingly, an object of the present invention is to provide an infrared reflector which is not easily deteriorated when film growth or heat treatment is carried out in an atmosphere containing oxygen, and a heating device having the infrared reflector.

A first aspect of the present invention is to provide an infrared reflector reflecting infrared light. The infrared reflector includes at least a multilayer structure in which any one of an Au film and Pt film, a dielectric film, and a substrate are formed in this order from the side of a body to be heated.

A second aspect of the present invention is to provide the infrared reflector of the first aspect, in which the dielectric film is configured of one or plurality of layers.

A third aspect of the present invention is to provide the infrared reflector of the second aspect, in which at least one layer of the dielectric film is formed of an oxide.

A fourth aspect of the present invention is to provide the infrared reflector of the first aspect, in which the substrate is formed of sapphire.

A fifth aspect of the present invention is to provide the infrared reflector of the first aspect, in which the dielectric film is formed of any one of NiO and TiO₂.

A sixth aspect of the present invention is to provide the infrared reflector of the second aspect, in which the dielectric film is formed of any one of NiO and TiO₂.

A seventh aspect of the present invention is to provide the infrared reflector of the third aspect, in which the dielectric film is formed of any one of NiO and TiO₂.

An eighth aspect of the present invention is to provide a heating device provided with the infrared reflector of the first aspect.

A ninth aspect of the present invention is to provide a heating device provided with the infrared reflector of the second aspect.

A tenth aspect of the present invention is to provide a heating device provided with the infrared reflector of the third aspect.

An eleventh aspect of the present invention is to provide a heating device provided with the infrared reflector of the fourth aspect.

A twelfth aspect of the present invention is to provide a heating device provided with the infrared reflector of the fifth aspect.

A thirteenth aspect of the present invention is to provide a heating device provided with the infrared reflector of the sixth aspect.

A fourteenth aspect of the present invention is to provide a heating device provided with the infrared reflector of the seventh aspect.

A fifteenth aspect of the present invention is to provide the heating device of the eighth aspect, in which the infrared reflector is disposed on the opposite side of a heat source from the body to be heated.

A sixteenth aspect of the present invention is to provide the heating device of the ninth aspect, in which the infrared reflector is disposed on the opposite side of a heat source from the body to be heated.

A seventeenth aspect of the present invention is to provide the heating device of the tenth aspect, in which the infrared reflector is disposed on the opposite side of a heat source from the body to be heated.

An eighteenth aspect of the present invention is to provide the heating device of the eleventh aspect, in which the infrared reflector is disposed on the opposite side of a heat source from the body to be heated.

A nineteenth aspect of the present invention is to provide the heating device of the twelfth aspect, in which the infrared reflector is disposed on the opposite side of a heat source from the body to be heated.

Since the infrared reflector of the present invention has the multilayer structure in which at least any one of the Au film and Pt film, the dielectric film, and the substrate are sequentially formed from the side of the body to be heated, infrared light emitted from the heat source can be effectively reflected and concentrated to the body to be heated by a metal of the Au film or Pt film. Accordingly, deterioration due to oxidation can be prevented.

In addition, the dielectric film is provided between the substrate and any one of the Au film and Pt film. Thus, even when the substrate is heated to be high temperature at the time when an oxide thin film is grown or thermally treated, the dielectric film can prevent Au or Pt in the Au film or Pt film from dispersing. Accordingly, the function to reflect infrared light is not deteriorated.

### BRIEF DESCRIPTION OF DRAWINGS

FIG. 1 is a view showing the structure of an infrared reflector of the present invention;

FIG. 2 is a view showing the structure of an infrared reflector of the present invention;

FIG. 3 is a graph showing a relationship between heating time and measured temperature of the infrared reflector configured of a sapphire substrate, Au film, and NiO film in this order;

FIG. 4 is a graph showing a relationship between Tc temperature and measured temperature of the infrared reflector configured of a sapphire substrate, SiO₂ film, Au film, and NiO film in this order;

FIG. 5 is a graph showing a relationship between Tc temperature and measured temperature of the infrared reflector configured of a sapphire substrate, NiO film, Au film, and NiO film in this order;

FIG. 6 is a graph showing a relationship between heating time and measured temperature of the infrared reflector configured of a ZnO substrate, Au film, and NiO film in this order;

FIG. 7 is a graph showing a relationship between heating time and measured temperature of the infrared reflector configured of a ZnO substrate, SiO₂ film, Au film, and NiO film in this order;

FIG. 8 is a graph showing a relationship between heating time and measured temperature of the infrared reflector configured of a ZnO substrate, NiO film, Au film, and NiO film in this order;

FIG. 9 is a graph showing a difference between infrared reflectance of a conventional infrared reflector and infrared reflectance of the infrared reflector of the present invention;

FIG. 10 is a graph showing a relationship between light wavelength and reflectance of the Au film and Pt film;

FIG. 11 is a view showing a schematic configuration of a heating device;

FIG. 12 is a view showing a schematic configuration of the heating device; and

FIG. 13 is a graph showing a difference in infrared reflectance of the conventional infrared reflector between an initial state and a state where the frequency of usage of the infrared reflector is high.

### DETAILED DESCRIPTION OF THE INVENTION

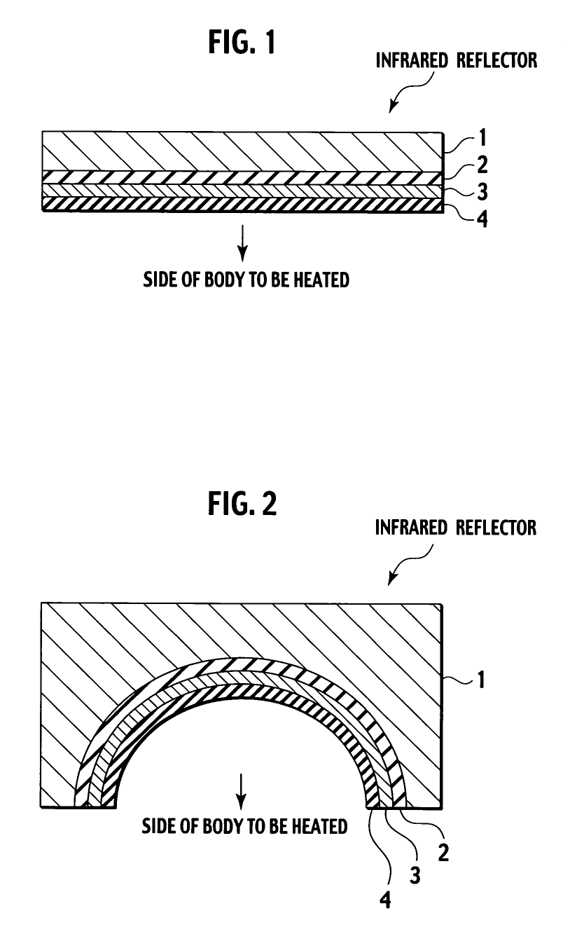

One embodiment of the present invention will be described below by referring to the drawings. FIG. 1 shows a cross-sectional structure of an infrared reflector of the present invention.

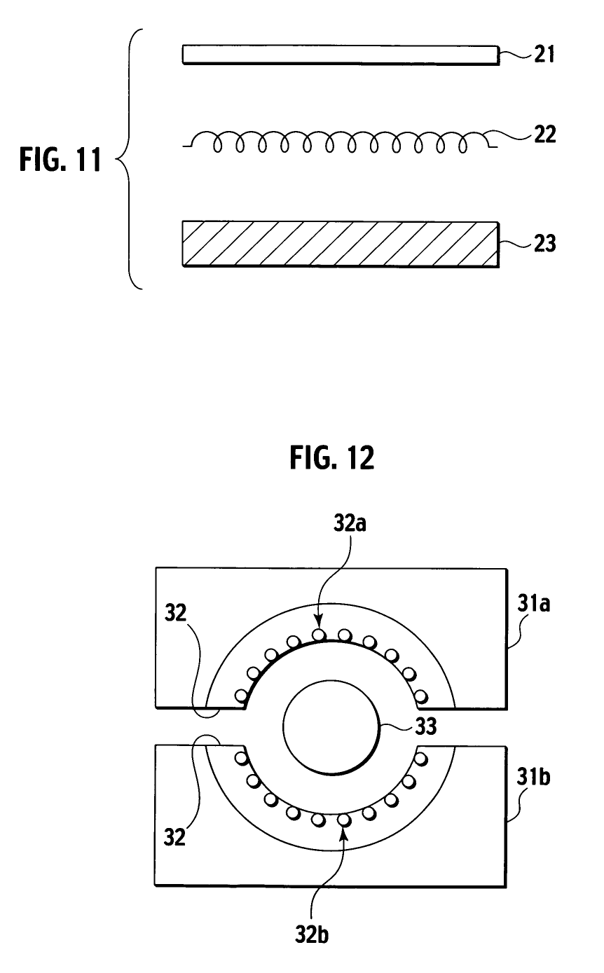

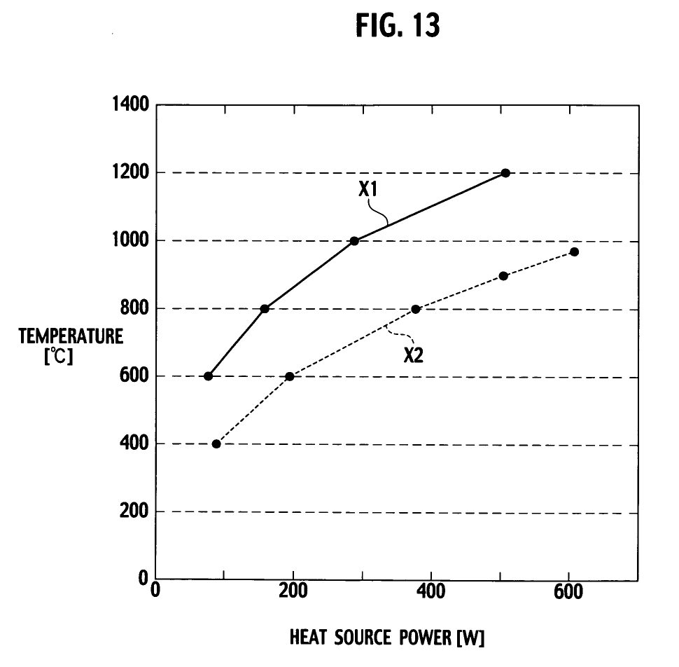

The infrared reflector has the structure in which a dielectric film 2, an Au (gold) film 3, and an oxide film 4 are sequentially formed on a substrate 1. As shown in FIG. 11, the infrared reflector with this configuration is used in such a manner that the oxide film 4 would face a body to be heated. Here, the body to be heated is an object which is heated when crystal growth of an oxide thin film or the like is carried out, when annealing processing is performed after an electrode is formed in manufacturing a device, or when annealing processing is conducted for activating a doped impurity, or the like.

The infrared reflector is supposed to be used under an atmosphere containing oxygen and high temperature. Thus, it is desirable that the substrate 1 be an oxide, such as sapphire (Al₂O₃), ZnO, SiON, or the like. Among these oxides, sapphire has high-purity and can be obtained with a relatively inexpensive cost, and thus is suitable.

FIG. 2 shows an infrared reflector having a different shape from that of FIG. 1. The configuration in which a dielectric film 2, an Au (gold) film 3, and an oxide film 4 are sequentially formed on a substrate 1 is the same as that of FIG. 1. However, FIGS. 1 and 2 are different in that in FIG. 2, each of the inner sides of the substrate 1, the dielectric film 2, and the Au (gold) film 3, and the oxide film 4 is formed in an arc shape. This is because a body to be heated is disposed inside the arc, as shown in FIG. 12. For the same reason described above, sapphire, among oxides, is suitable for a material of the substrate 1. If infrared reflectors like those of FIGS. 1 and 2 are used, a relationship between an infrared reflector and a body to be heated is shown in FIGS. 11 and 12.

In addition, if an oxide thin film is formed on a substrate for growth, such as a ZnO substrate, sapphire substrate, or SiON substrate, the oxide thin film is formed in an oxygen atmosphere. Accordingly, an easily-oxidized material, such as Ti, Ni, W, or Ta, cannot be used as the metal reflecting infrared light. Thus, a metal, which is hardly oxidized and has resistance to the temperature exceeding 500°, such as Au or Pt (platinum), is suitable.

FIG. 10 shows reflectance of Au and Pt in relation to light wavelength. It can be seen from the figure that reflectance of both Au (solid line) and Pt (broken line) are high in an infrared region. However, the reflectance of Au in the infrared region is almost 100%, and Au is more preferable as a metal reflecting infrared light.

As described above, Au or Pt is desirable for the metal reflecting infrared light. Furthermore, following improvement was made. Since Au and Pt, which are the best as the metal reflecting infrared light, are chemically stable, they peel off the substrate easily. In addition, Au and Pt, particularly Au, have a characteristic of being dispersed very fast at relatively low temperature (500° or less) with almost any material.

For this reason, if Au or Pt is directly used to form a substrate 1 and the substrate 1 is used in an atmosphere containing oxygen, a problem of forming holes in the Au film or Pt film or damaging the film is caused by dispersion. The inventors of the present invention found that the dispersion is prevented by the dielectric film 2, such as an oxide film or nitride film.

Accordingly, as shown in FIGS. 1 and 2, the dielectric film 2 is formed on the back surface of the substrate 1, and then the Au film or the Pt film is further formed on the dielectric film 2. As the dielectric film 2, an oxide, such as NiO, SiO₂, TiO₂, or Cr₂O₃, or a nitride, such as AlN or SiN, is known. In general, nitride has high insulation properties. However, when nitride is disposed in the atmosphere for crystal growth and exposed to high temperature as in the present invention, there is a possibility that oxidation proceeds with time. As a result, barrierability against dispersion may be deteriorated. Accordingly, it is desirable to use a stable oxide which hardly advances oxidation even at high temperature.

Note that the dielectric film inserted between the substrate 1 and any one of the Au film and the Pt film may be formed by multiple layers in place of one layer. In addition, these metals are generally chemically stable, and easily peel off the dielectric film or the like. However, as for the Au film, the inventors of the present invention found that the Au film 3 and the oxide film 4 are formed by using the annealing method (reverse annealing), which will be described later, so that they can be tightly adhered to each other. In addition, the Pt film may be oxidized by annealing by using a film with high chemical activeness, such as Ni, Ti, or Cr, as an adhesive.

The infrared reflector in the heating device has the above-described multiplayer structure. Accordingly, in a case where the Au film or Pt film reflects infrared light emitted from a heat source to irradiate a body to be heated with the reflected infrared light, and not only when crystal growth is carried out, but also heat treatment like annealing processing, which is performed after an electrode is formed, or annealing processing, which is conducted for activating a doped impurity, is carried out, deterioration of the infrared reflector can be prevented.

Specifically, the infrared reflector of FIG. 1 was configured of, for example, a sapphire film as the substrate 1, an NiO film as the dielectric film 2, and an NiO film as the oxide film 4. The infrared reflector with this configuration is formed as follows.

Firstly, an Ni film is formed by evaporation with the thickness of approximately 20 nm to 1000 nm on the back surface of the sapphire substrate as the substrate 1. Subsequently, the sapphire substrate with Ni is disposed in the atmosphere containing 5% or more of oxygen and is heated at approximately 600° C. to 900° C. for approximately 10 to 30 minutes. After this process, Ni is oxidized, and an NiO film (dielectric film 2) in a slightly greenish color is formed.

Thereafter, to the back surface on which the NiO film (dielectric film 2) is formed, an Ni film is laminated by evaporation with the thickness of 5 nm to 10 nm and an Au film is disposed on the Ni film by evaporation with the thickness of 100 nm to 1000 nm. Subsequently, in the atmosphere containing 1% or more of oxygen, a wafer having the configuration of the sapphire substrate, thermally-oxidized NiO film, Ni film, and Au film in this order is heated at approximately 500° C. to 800° C. for approximately 15 to 60 minutes. After this process, the Ni film and the Au film change their places, and the Ni film coming to the uppermost layer is oxidized by oxygen in the atmosphere (hereinafter referred to as reverse annealing).

In the above-described example, the infrared reflector finally has the configuration of the sapphire substrate (substrate 1), thermally-oxidized NiO film (dielectric film 2), Au film (Au film 3), and ultrathin NiO film (oxide film 4) in this order.

In addition, if a Pt film is used in place of the Au film in the above-described configuration, a Ti film with the thickness of 5 nm to 100 nm is firstly formed on the substrate 1, and subsequently the Pt film is formed with the thickness of 100 nm to 1000 nm by evaporation. Thereafter, the annealing processing is carried out at 700° C. or more, so that O (oxygen) is dispersed from the substrate 1 to cause the Ti film to be a TiO₂ (titanium oxide) film. As a result, the configuration of the substrate 1, TiO₂ (dielectric film 2), and Pt film in this order can be obtained. Accordingly, effects similar to those of the case where the Au film is used can be obtained. Note that if an oxide is not used as the substrate 1, the above-described reverse annealing may be performed similar to the case of Au.

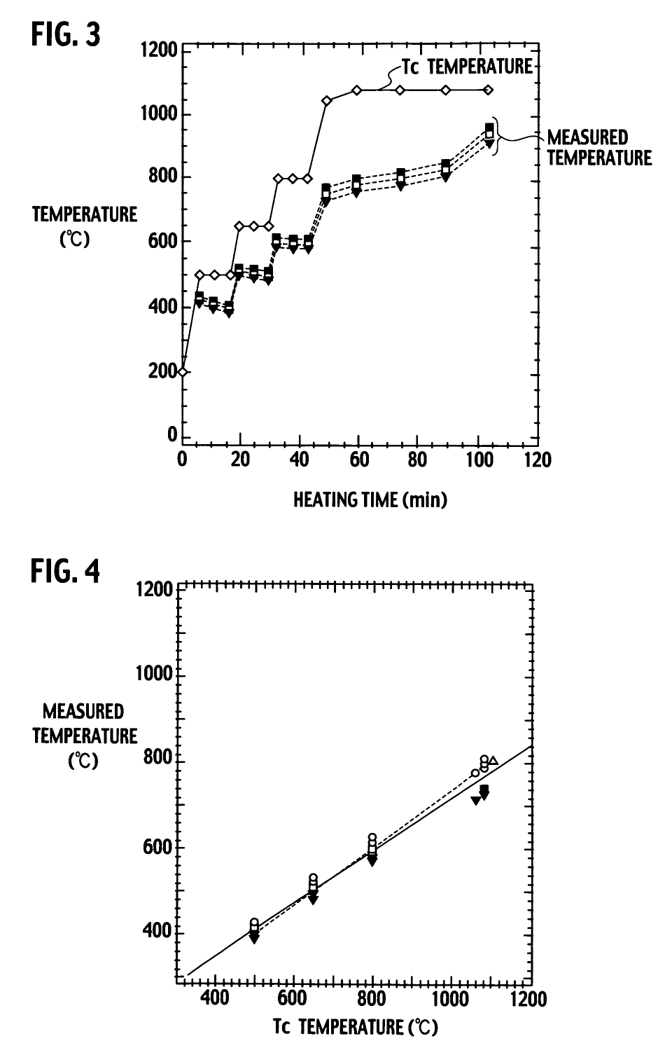

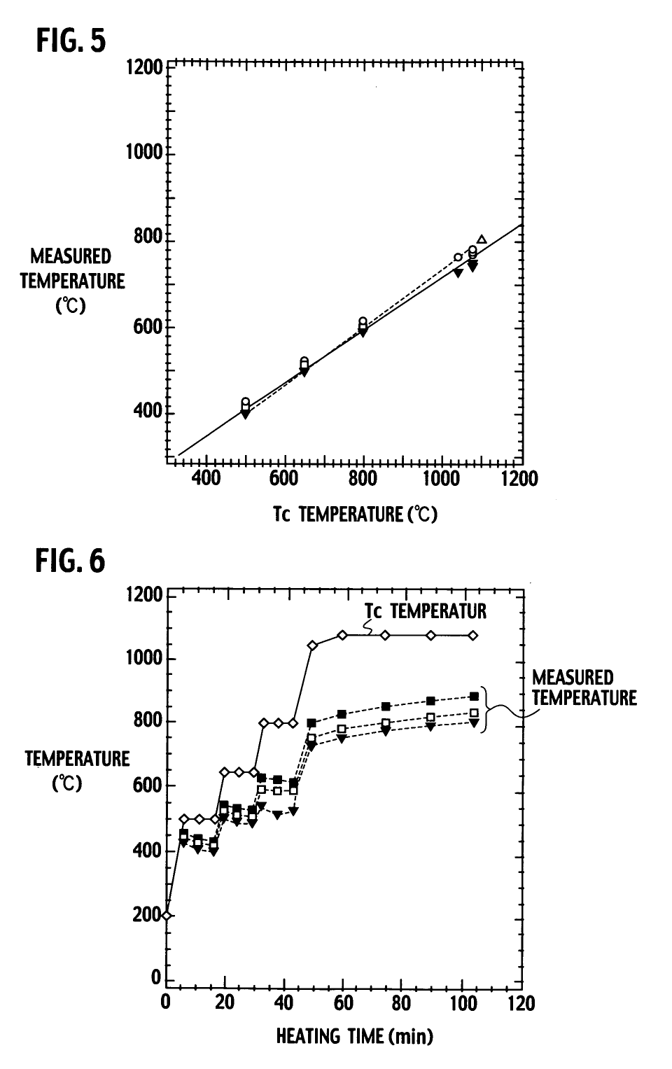

The foregoing description was validated by experiments. FIGS. 3 to 8 are graphs showing results of the experiments. FIGS. 3, 6, 7, and 8 are graphs, in each of which the horizontal axis is heating time of the infrared reflector (unit is a minute) and the longitudinal axis is temperature. In addition, FIGS. 4 and 5 are graphs, in each of which the horizontal axis is actual temperature of the infrared reflector (substrate temperature) and the longitudinal axis is measured temperature measured by an infrared thermometer (pyrometer).

The actual temperature of the infrared reflector was measured by affixing an Au—Si film, Al—Si film, and Al film on the infrared reflector by using an In film. The Au—Si film and the Al—Si film are mixed at 363° C. and 577° C., respectively (which is referred to as eutectic), and the Al film melts at 660° C. These values are thermodynamically determined and do not change depending on an experimental environment. Thus, the actual temperature can be calculated.

FIG. 3 shows actual temperature of the infrared reflector plate and measured values measured by the infrared thermometer in a case where a sapphire substrate is used as the substrate and the infrared reflector is formed so as to be configured of the sapphire substrate, Au film, and NiO film in this order by the reverse annealing, and then temperature of the infrared reflector is changed with heating time. In FIG. 3, rhomboids show thermocouple temperature Tc (equivalent to the actual temperature of the infrared reflector) behind the infrared reflector, and black squares show values obtained by setting the infrared emittance (thermal emittance) e of the Au film to be 0.4, white squares show values obtained by setting e to be 0.5, and black inversed triangles show values obtained by setting e to be 0.6. These values (measured temperature) are measured by the infrared thermometer.

As the Tc temperature shown by the rhomboids increases with the heating time, and the measured values shown by the back squares, white squares, and black inversed triangles also increase. The Tc temperature and the measured values obtained from the experiment have the following relationship. Suppose a case where the Tc temperature is in the range from 500° C. to 800° C. In this case, the measure values are constant when the Tc temperature is constant. In contrast, think about a case where the Tc temperature is the high temperature of 1080° C. (in the figure, at the region where the temperature is the highest in the graph of the rhomboids). In this case, even if the TC temperature is maintained at 1080° C., the measured temperature increases with time. In addition, as the elapsed time becomes longer, the measured temperature rapidly increases. In other words, in the configuration of the sapphire substrate, Au film and NiO film in this order, the Au film is directly formed on the sapphire substrate (oxide layer), and thus the problem of forming holes in the Au film is caused by dispersion. As a result, monitoring could not be accurately performed.

An experiment was conducted by using sapphire substrate as the substrate and measurement similar to that described above was performed after the following processes were carried out thereon. Specifically, after an SiO₂ as the dielectric film is formed on this sapphire substrate, the reverse annealing was conducted so that the infrared reflector would have the configuration of the sapphire substrate, SiO₂ film, Au film, and NiO film in this order. In FIG. 4, the relationship between the measured temperature measured by the infrared thermometer and the Tc temperature is shown. The longitudinal axis shows the measured temperature and the horizontal axis shows the Tc temperature. Here, white circles show values obtained by setting the infrared emittance (thermal emittance) e of the Au film to be 0.2, white squares show values obtained by setting e to be 0.3, and black inversed triangles show values obtained by setting e to be 0.4. These values are measured by the infrared thermometer.

The relationship between the Tc temperature and the measured values maintains linearity (proportional relation) in the range from approximately 300° C. to 900° C. Moreover, even when the temperature exceeds 900° C., the linearity is relatively well-maintained, and variation of data at the Tc temperature of 1080° C. is not large. Thus, it can be seen that the SiO₂ film (dielectric film) prevents Au from dispersing.

In FIG. 5, a sapphire substrate was used as a substrate and heating experiment was conducted after the following processes were carried out thereon. Specifically, after an NiO film as the dielectric film is formed on this sapphire substrate, the reverse annealing was performed so that the infrared reflector would have the configuration of the sapphire substrate, NiO film, Au film, and NiO film in this order. FIG. 5 shows results of the experiment. In FIG. 5, white circles show values obtained by setting the infrared emittance (thermal emittance) e of the Au film to be 0.5, white squares show values obtained by setting e to be 0.6, and black inversed triangles show values obtained by setting e to be 0.7. These values are measured by the infrared thermometer.

Here, in the case where the Tc temperature is not only in the range from 500° C. to 800° C. but in the high temperature of 1080° C. and is maintained at 1080° C., the measured temperature shown by the white circles, white squares, and black inversed triangles hardly change with time. This is more preferable than the case where the SiO₂ film was formed as the dielectric film like the case described in FIG. 4.

The experiment was conducted by using a ZnO substrate as the substrate and similarly measuring the infrared reflector formed by the reverse annealing so as to have the configuration of the ZnO substrate, Au film, and NiO film in this order. FIG. 6 shows results of the experiment. In FIG. 6, in a case where the temperature of the infrared reflector is changed with the heating time, the actual temperature of the infrared reflector (substrate temperature) and the measured values measured by the infrared thermometer are shown. In FIG. 6, rhomboids show Tc temperature, black squares show values obtained by setting infrared emittance (heat emittance) e of the Au film to be 0.4, white squares show values obtained by setting e to be 0.5, and black inversed triangles show values obtained by setting e to be 0.6. These values are measured by the infrared thermometer.

The Tc temperature and the measured values obtained from the experiment have the following relationship. Suppose a case where the Tc temperature is in the range from 500° C. to 800° C. In this case, the measure values are constant when the Tc temperature is constant. By contrast, think about a case where the Tc temperature is the high temperature of 1080° C. In this case, even if the TC temperature is maintained at 1080° C., the measured temperature increases with time (in the figure, at the region where the temperature is the highest in the graph of the rhomboids) by approximately 50° C. from the initial temperature at the time when the Tc temperature became 1080° C. Similar to the case described in FIG. 3, this is because in the configuration in which the ZnO substrate, the Au film and the NiO film are formed in this order, the Au film is directly formed on the ZnO substrate (oxide layer), and thus the problem of forming holes in the Au film is caused by dispersion. As a result, monitoring cannot be accurately performed.

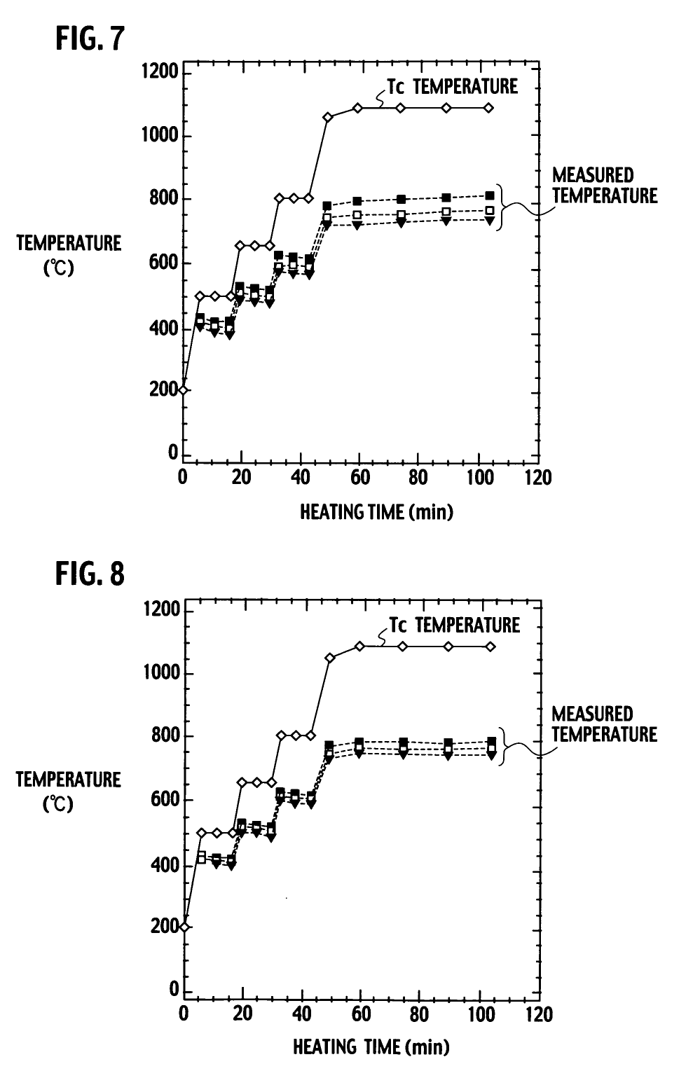

In FIG. 7, a ZnO substrate is used as the substrate, and measurement similar to that described above was conducted after the following processes were carried out thereon. Specifically, after an SiO₂ film as the dielectric film is formed on this ZnO substrate, the reverse annealing was performed so that the infrared reflector would have the configuration of the ZnO substrate, SiO₂ film, Au film, and NiO film in this order. FIG. 7 shows results of the experiment. In FIG. 7, rhomboids show Tc temperature, black squares show values obtained by setting infrared emittance (thermal emittance) e of the Au film to be 0.2, white squares show values obtained by setting e to be 0.3, and black inversed triangles show values obtained by setting e to be 0.4. These values are measured by the infrared thermometer.

Here, when the Tc temperature is in the range from 500° C. to 800° C., the measured values are also constant with the Tc temperature being a constant value. However, when the Tc temperature becomes high temperature of 1080° C. and is maintained at 1080° C., the measured temperature shown by the black squares, white squares, and black triangles slightly increase by 13° C., which is from 752° C. to 765° C. In other words, there is almost no change with time. Thus, it can be seen that the SiO₂ film (dielectric film) prevents Au from dispersing.

In FIG. 8, a ZnO substrate was used as a substrate and, measurement was carried out after the following processes were performed thereon. Specifically, after an NiO film, in place of an SiO₂ film, as a dielectric film is formed on this ZnO substrate, the reverse annealing was conducted so that the infrared reflector would have the configuration of the ZnO substrate, NiO film, Au film, and NiO film in this order. In FIG. 8, rhomboids show Tc temperature, which is the actual temperature of the infrared reflector, black squares show values obtained by setting infrared emittance (thermal emittance) e of the Au film to be 0.4, white squares show values obtained by setting e to be 0.5, and black inversed triangles show values obtained by setting e to be 0.6. These values are measured by the infrared thermometer.

Here, in the case where the Tc temperature is not only in the range from 500° C. to 800° C. but in the high temperature of 1080° C. and is maintained at 1080° C., the measured temperature shown by the back squares, white squares, and black inversed triangles hardly change with time. Note that the change of the measured temperature from the temperature at the time when the Tc temperature initially became 1080° C. was from 761° C. to 762° C. Accordingly, this is extremely preferable than the case where the SiO₂ film was used as the dielectric film like the case described in FIG. 7.

When the results of the above-described experiments are summed up, an NiO film is most desirable for the dielectric film 2 to be provided between the substrate 1 and any one of the Au film 3 and the Pt film. Moreover, when Au is used as the reflection metal, the adhesiveness between a base layer, such as the dielectric film 2, and the Au film 3 becomes extremely well by the reverse annealing. Accordingly, it is preferable to have the configuration of an oxide substrate, NiO film, Au film, and NiO film in this order.

A method for forming an oxide thin film by using a heating device will be described below. Here, an example that a ZnO-based thin film is formed as an oxide thin film will be described. Here, the ZnO-based material is a mixed crystal material using ZnO as a base, and is a material in which one part of Zn is replaced with an element in IIA or IIB family or one part of O is replaced with an element in VIB family, or is the combination of the both. Then, the infrared reflector of the present invention is formed with the configuration of, for example, a sapphire substrate, NiO film, Au film, and NiO film in this order.

This ZnO substrate is put in a load lock chamber. After that, to remove water therefrom, the ZnO substrate is heated at 200° C. for approximately 30 minutes under the vacuum environment of approximately 1×10⁻⁵ Torr to 1×10⁻⁶ Torr. Then, the substrate is introduced into a growth chamber with a wall surface chilled by liquid nitrogen through a conveyance chamber with the vacuum of approximately 1×10⁻⁹ Torr, so that a ZnO based thin film is grown by using the MBE method.

By heating a Knudsen cell to be approximately 260° C. to 280° to be sublimated, Zn is supplied as Zn molecular beams. In the Knudsen cell, high-purity Zn with 7 N is put in a crucible formed of pBN. One example of the IIA family elements is Mg, and Mg is also supplied as Mg molecular beams by heating high-purity Mg with 6 N in a cell having a similar cell structure at 300° C. to 400° C. to be sublimated. As oxygen, an O₂ gas with 6 N is used and supplied to a RF radical cell with approximately 0.1 sccm to 5 sccm. The RF radical cell includes a cylindrical discharging tube in which small orifices are opened in one portion thereof through a SUS tube with an electrobrightening inner surface. Then, the RF high-frequency of approximately 100 W to 300 W is applied to generate plasmas. The generated plasmas are caused to be O radical in which reaction activity is increased and supplied as an oxygen source. The plasmas are important, and even if an O₂ raw gas is added, a ZnO-based thin film is not formed.

For the substrate, if general resistance heating is performed, a carbon heater coated with SiC is used. Metal based heaters, the metal is for example W, cannot be used because they are oxidized. In addition, there is a heating method using lamp heating, laser heating, and the like. However, the heating method can be any method as long as it has resistance to oxidation.

After heating up to 750° C. or more for approximately 30 minutes under the vacuum of approximately 1×10⁻⁹ Torr, shutters of the radical cell and the Zn cell are opened to start the growth of the ZnO thin film. At this time, to obtain a flat film, the substrate temperature should be 750° C. or more regardless of which kind of film is formed (see, Japanese Patent Application No. 2007-27182).

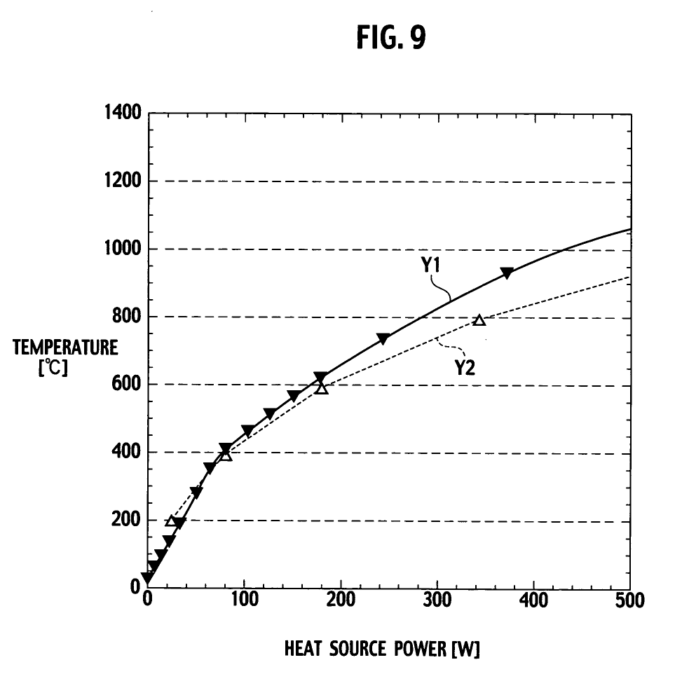

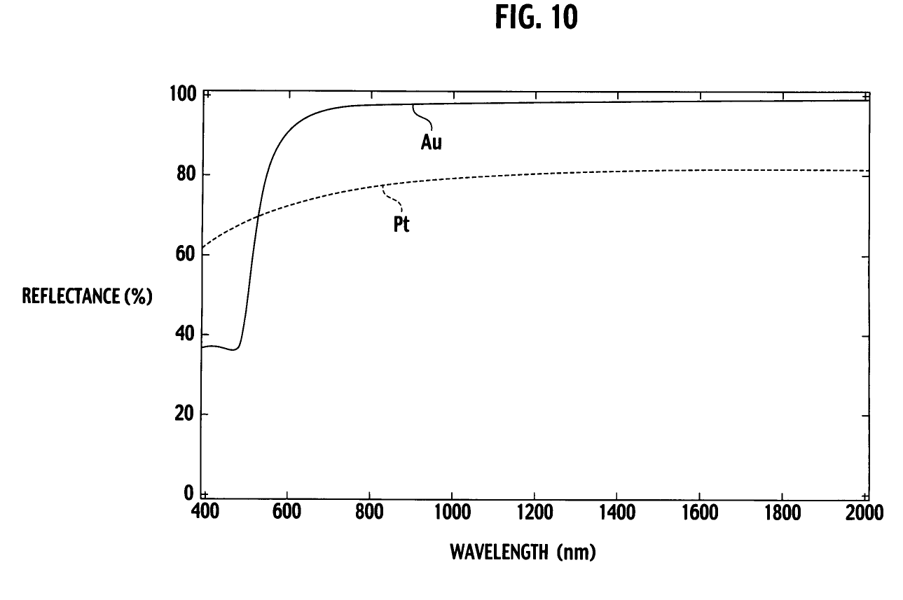

As described above, the infrared reflector is used in order to effectively use infrared light emitted from the heat source inside the heating device in the atmosphere containing oxygen. FIG. 9 shows results of comparison between the infrared reflector with the conventional structure and the infrared reflector of the present invention. In FIG. 9, the horizontal axis is heat source power (W) of the heat source and the longitudinal axis is temperature of the body to be heated.

In FIG. 9, reference numeral Y1 (solid line) shows the case where the configuration of the sapphire substrate, NiO film, Au film, and NiO film of the present invention is used, and reference numeral Y2 (broken line) shows the case where inconel with the conventional configuration is used. In addition, both Y1 and Y2 show data obtained by the experiment carried out after the infrared reflectors were continuously used in the heating device for a couple dozen times.

Here, in the case of Y2 using the infrared reflector with the conventional configuration, when the infrared reflector is continuously used in the heating device for a couple dozens times, the reflection surface is blackened to deteriorate the capability of reflecting infrared light. Accordingly, the temperature rise of the body to be heated is slow even if the heat source power is increased. By contrast, it can be seen that in the case of Y1 using the infrared reflector with the configuration of the present invention, temperature rise efficiency of the body to be heated is high when the heat source power is increased. In other words, the infrared reflector of the present invention will not be deteriorated due to oxidation or dispersion of the reflection metal even if it is exposed to high temperature under the atmosphere containing oxygen.

In this manner, the present invention of course includes various embodiments which are not described herein. Accordingly, the technical scope of the present invention is only defined by claims that are properly based on the foregoing description.

What is claimed:

1. An infrared reflector comprising at least a multilayer structure in which any one of an Au film and Pt film, a dielectric film, and a substrate are formed in this order from the side of a body to be heated.

2. The infrared reflector of claim 1, wherein the dielectric film is configured of one or a plurality of layers.

3. The infrared reflector of claim 2, wherein at least one layer of the dielectric film is formed of an oxide.

4. The infrared reflector of claim 1, wherein the substrate is formed of sapphire.

5. The infrared reflector of claim 1, wherein the dielectric film is formed of any one of NiO and TiO₂.

6. The infrared reflector of claim 2, wherein the dielectric film is formed of any one of NiO and TiO₂.

7. The infrared reflector of claim 3, wherein the dielectric film is formed of any one of NiO and TiO₂.

8. A heating device comprising the infrared reflector of claim 1.

9. A heating device comprising the infrared reflector of claim 2.

10. A heating device comprising the infrared reflector of claim 3.

11. A heating device comprising the infrared reflector of claim 4.

12. A heating device comprising the infrared reflector of claim 5.

13. A heating device comprising the infrared reflector of claim 6.

14. A heating device comprising the infrared reflector of claim 7.

15. The heating device of claim 8, wherein the infrared reflector is disposed on the opposite side of a heat source from the body to be heated.

16. The heating device of claim 9, wherein the infrared reflector is disposed on the opposite side of a heat source from the body to be heated.

17. The heating device of claim 10, wherein the infrared reflector is disposed on the opposite side of a heat source from the body to be heated.

18. The heating device of claim 11, wherein the infrared reflector is disposed on the opposite side of a heat source from the body to be heated.

19. The heating device of claim 12, wherein the infrared reflector is disposed on the opposite side of a heat source from the body to be heated.
